(19) United States
(12) Patent Application Publication
(10) Pub. No.: US 2025/0124418 A1
(43) Pub. Date: Apr. 17, 2025

(54) COMMODITY REGISTRATION SUPPORT APPARATUS, COMMODITY REGISTRATION SUPPORT SYSTEM, AND METHOD

(71) Applicant: TOSHIBA TEC KABUSHIKI KAISHA, Tokyo (JP)

(72) Inventor: Makoto Hatayama, Izunokuni Shizuoka (JP)

(21) Appl. No.: 18/640,025

(22) Filed: Apr. 19, 2024

(30) Foreign Application Priority Data
Oct. 16, 2023 (JP) 2023-178267

(51) Int. Cl. G06Q 20/20

(52) U.S. Cl. CPC G06Q 20/208

(57) ABSTRACT

An edge gateway supports an operation of a cart terminal that registers a commodity. The edge gateway includes a video acquiring unit that acquires a video of the commodity being put in a basket that stores the commodity and an identification number of the basket, a commodity counting unit that counts, from the acquired video, a first number that is the number of commodities put in the basket, a commodity registration information acquiring unit that acquires a second number that is a number of commodities read by the cart terminal until registration completion, and a number-of-commodities comparison information output unit that outputs, on condition that the first number and the second number do not match, the identification number, the first number, and the second number in order to cause a portable terminal carried by a store clerk to alert the store clerk.

### CROSS-REFERENCE TO RELATED APPLICATION

This application is based upon and claims the benefit of priority from Japanese Patent Application No. 2023-178267, filed on Oct. 16, 2023, the entire contents of which are incorporated herein by reference.

### FIELD

Embodiments described herein relate generally to a commodity registration support apparatus, a commodity registration support system, and a method.

### BACKGROUND

There has been proposed a shopping system that transmits, to a server, an image of a commodity captured if the customer put a commodity in a shopping cart and specifies a commodity with a server, thereby performing registration and settlement for the commodity.

The shopping system explained above is a system that is effective from the viewpoint of reducing a register waiting time. However, in order to securely image the commodity put in the shopping cart, the system causes the customer to put the commodity only from a determined place. Therefore, the shopping cart of the related art needs to be substantially remodeled.

### BRIEF DESCRIPTION OF THE DRAWINGS

FIG. 1 is a block diagram illustrating an example of a schematic configuration of a commodity sales data processing system in an embodiment;

FIG. 2 is a hardware block diagram illustrating an example of a hardware configuration of a cart terminal;

FIG. 3 is a diagram illustrating an example of a data structure of a commodity master;

FIG. 4 is a diagram illustrating an example of a data structure of a commodity registration file;

FIG. 5 is a hardware block diagram illustrating an example of a hardware configuration of an edge gateway;

FIG. 6 is a diagram illustrating an example of a data structure of a commodity count file;

FIG. 7 is a hardware block diagram illustrating an example of a hardware configuration of a portable terminal;

FIG. 8 is a hardware block diagram illustrating an example of a hardware configuration of a checkout machine;

FIG. 9 is a functional block diagram illustrating an example of a functional configuration of the cart terminal;

FIG. 10 is a functional block diagram illustrating an example of a functional configuration of the edge gateway;

FIG. 11 is a functional block diagram illustrating an example of a functional configuration of the portable terminal;

FIG. 12 is a functional block diagram illustrating an example of a functional configuration of the checkout machine;

FIG. 13 is a flowchart illustrating an example of a flow of processing performed by the cart terminal;

FIG. 14 is a flowchart illustrating an example of a flow of processing performed by the edge gateway;

FIG. 15 is a flowchart illustrating an example of a flow of processing performed by the portable terminal;

FIG. 16 is a flowchart illustrating an example of a flow of processing performed by the checkout machine;

FIG. 17 is a schematic perspective view of a self-service POS terminal included in a commodity sales data processing system in a second embodiment;

FIG. 18 is a hardware block diagram illustrating an example of a hardware configuration of a self-service POS terminal;

FIG. 19 is a functional block diagram illustrating an example of a functional configuration of the self-service POS terminal; and

FIG. 20 is a flowchart illustrating an example of a flow of processing performed by the self-service POS terminal.

### DETAILED DESCRIPTION

An aspect of embodiments is to provide a commodity registration support apparatus, a commodity registration support system, and a method that, without substantially remodeling the shopping cart of the related art, enable a customer to perform commodity registration by himself or herself.

A commodity registration support apparatus in an embodiment is a commodity registration support apparatus that reads information for uniquely specifying a commodity to be purchased, thereby supporting an operation of a commodity registration apparatus that registers the commodity, the commodity registration support apparatus including a video acquiring unit, a counting unit, a number-of-commodities acquiring unit, and a number-of-commodities comparison information output unit. The video acquiring unit acquires a video of the commodity, the information of which was read, being put in a storing unit that stores the commodity, the video being captured by an imaging apparatus that images the storing unit, and an identification number for identifying the storing unit. The counting unit counts, from the video acquired by the video acquiring unit, a first number that is a number of commodities put in the storing unit. The number-of-commodities acquiring unit acquires a second number that is a number of commodities read by the commodity registration apparatus until registration completion. The number-of-commodities comparison information output unit outputs, on condition that the first number and the second number do not match, the identification number, the first number, and the second number in order to cause a terminal apparatus to alert a store clerk.

Embodiments are explained in detail below with reference to the drawings. Note that embodiments are not limited by the embodiments explained below.

### First Embodiment

A commodity sales data processing system 1 according to a first embodiment of the present disclosure is explained below with reference to the drawings.

### Schematic Configuration of the Commodity Sales Data Processing System

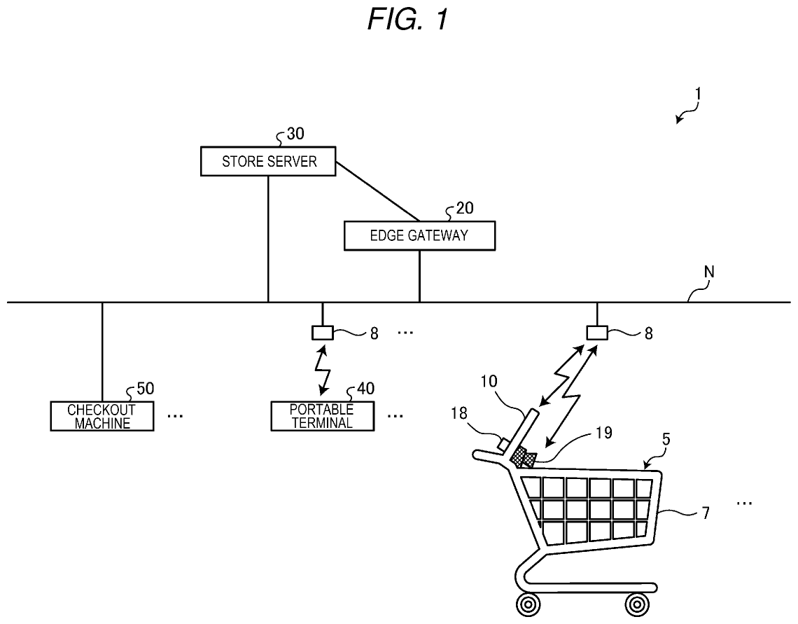

FIG. 1 is a block diagram illustrating an example of a schematic configuration of the commodity sales data processing system according to the embodiment. The commodity sales data processing system 1 is a system that supports shopping of a customer in a store.

The commodity sales data processing system 1 includes a shopping cart 5, an edge gateway 20, a store server 30, a portable terminal 40, and a checkout machine 50.

A customer causes the shopping cart 5 to read identification information (for example, a commodity code) for identifying a commodity to be purchased while walking and pushing the shopping cart 5. The shopping cart 5 stores the commodity, the identification information of which was read. The shopping cart 5 includes a basket 7, a cart terminal 10, a scanner 18, and a camera 19.

The commodity to be purchased by the customer is put in the basket 7. The basket 7 stores the commodity put therein. The basket 7 is an example of the storing unit in the present disclosure. Note that, since a plurality of shopping carts 5 are present in the store, an identification number for uniquely specifying the basket 7 of each of the shopping carts 5 is attached to the shopping cart 5. The identification number is hereinafter referred to as cart ID.

The cart terminal 10 registers the commodity, the identification information of which was read. The cart terminal 10 transmits a commodity registration result to the edge gateway 20 or the store server 30 explained below via a plurality of access points 8, which are repeaters of wireless communication, installed in the store and an in-store network N. The cart terminal 10 is an example of the commodity registration apparatus in the present disclosure.

The scanner 18 reads a code symbol such as a barcode attached to the commodity, thereby acquiring identification information (for example, a commodity code) of the commodity registered in the code symbol.

The camera 19 is installed in the shopping cart 5 to be able to image the entire basket 7 and, for a period until the customer causes the shopping cart 5 to read code symbols of all commodities to be purchased, captures a video of the commodities being put in the basket 7. The camera 19 transmits the captured video to the edge gateway 20 explained below via the access points 8 and the in-store network N in correlation with a cart ID for specifying the shopping cart 5 in which the camera 19 is installed. Note that, if the shopping cart 5 includes upper and lower two baskets, cameras 19 are respectively provided in the upper basket and the lower basket.

The edge gateway 20 collects the video captured by the camera 19 via an interface such as a serial interface, a USB, or a wireless or wired LAN. The edge gateway 20 acquires a commodity registration result from the cart terminal 10. The edge gateway 20 analyzes the acquired video and counts the number of commodities put in the basket 7. At this time, the edge gateway 20 performs image processing such as well-known skeleton estimation, thereby recognizing the positions of an arm and a hand of the customer. Further, the edge gateway 20 recognizes that the hand of the customer is present above the basket 7 and an object left (separated from) the hand, thereby detecting that the customer put a commodity in the basket 7 of the shopping cart 5 and the number of commodities put in the basket 7. The edge gateway 20 compares the counted number of commodities (a first number) and the number of commodities in the commodity registration result (a second number). If the first number and the second number do not match, the edge gateway 20 notifies, to the portable terminal 40 explained below, the cart ID and an indication that the first number and the second number do not match. Note that the edge gateway 20 is an example of the commodity registration support apparatus in the present disclosure.

The store server 30 manages an entire transaction of commodities in the store. For example, the store server 30 transmits, to the cart terminal 10, content of a sequentially updated commodity master, which is a master file in which commodity information of commodities offered in the store is registered. The store server 30 acquires the commodity registration result from the cart terminal 10 and issues a transaction ID for uniquely specifying a transaction. The store server 30 notifies the issued transaction ID to the cart terminal 10. That is, the transaction ID corresponds to the commodity registration result transmitted from the cart terminal 10 in a one-to-one relation. If the customer performs checkout in the checkout machine 50 explained below, the store server 30 receives the transaction ID transmitted from the checkout machine 50 and notifies the commodity registration result corresponding to the transaction ID to the checkout machine 50.

The portable terminal 40 is carried by a store clerk of the store and exchanges various kinds of information between the portable terminal 40 and the store server 30 or between the portable terminals 40. The portable terminal 40 is, for example, a smartphone or a tablet terminal. The portable terminal 40 acquires, from the edge gateway 20, information concerning the commodity registration result of the customer, for example, the cart ID and the information indicating the first number and the second number do not match. If the first number and the second number do not match, the portable terminal 40 alerts the store clerk. The store clerk noticing the alert goes to the shopping cart 5 having the relevant cart ID, explains the situation to the customer, and, for example, checks the commodity put in the basket 7. Note that the portable terminal 40 is an example of the terminal apparatus in the present disclosure.

The checkout machine 50 is an apparatus with which the customer who completed the registration of the commodity performs checkout (settlement). The checkout machine 50 reads the transaction ID from the cart terminal 10 and notifies the read transaction ID to the store server 30. The checkout machine 50 acquires the commodity registration result corresponding to the transaction ID. Thereafter, the checkout machine 50 performs settlement processing with a settlement method designated by the customer. Note that a plurality of checkout machines 50 may be provided in the store to make checkout processing efficient.

### Hardware Configuration of the Cart Terminal

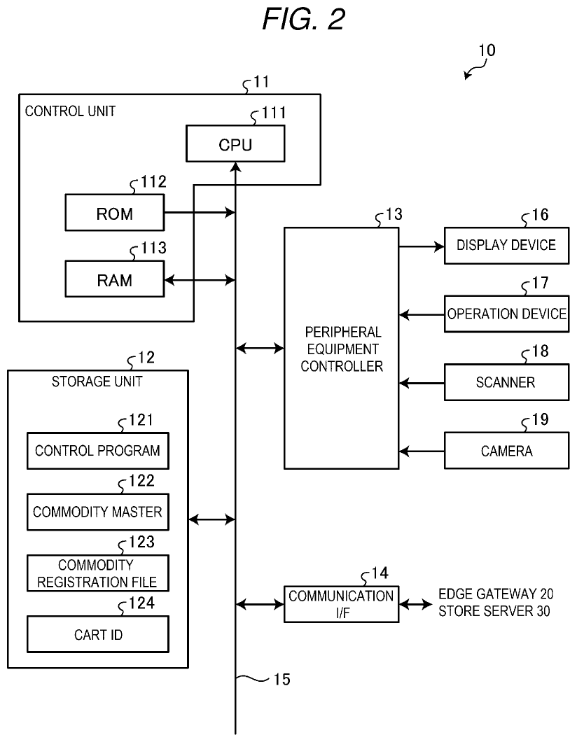

A hardware configuration of the cart terminal 10 is explained with reference to FIG. 2. FIG. 2 is a hardware block diagram illustrating an example of the hardware configuration of the cart terminal.

The cart terminal 10 includes a control unit 11, a storage unit 12, a peripheral equipment controller 13, and a communication I/F (interface) 14.

The control unit 11 controls an operation of the entire cart terminal 10. The control unit 11 includes a CPU (Central Processing Unit) 111, a ROM (Read Only Memory) 112, and a RAM (Random Access Memory) 113. The CPU 111 is connected to the ROM 112 and the RAM 113 via an internal bus such as an address bus or a data bus. The CPU 111 loads, in the RAM 113, various programs stored in the ROM 112 and the storage unit 12. The CPU 111 operates according to the various programs loaded in the RAM 113 to control the operation of the cart terminal 10. That is, the control unit 11 has a configuration of a general computer.

The storage unit 12 is a storage device such as a HDD (Hard Disk Drive) or an SSD (Solid State Drive) connected to the control unit 11 via an internal bus 15. The storage unit 12 may be a nonvolatile memory such as a flash memory in which stored information is retained even if a power supply is turned off. The storage unit 12 stores a control program 121, a commodity master 122, a commodity registration file 123, and a cart ID 124.

The control program 121 is a program for controlling the operation of the entire cart terminal 10. The control program 121 may be provided in a state in which the control program 121 is stored in the storage unit 12 or may be provided by being recorded in a computer-readable non-transitory recording medium such as a CD-ROM, a flexible disk (FD), a CD-R, or a DVD as a file of an installable format or an executable format. The control program 121 may be stored on a computer connected to a network and provided by being downloaded through the network. Further, the control program 121 may be provided or distributed through a network such as the Internet.

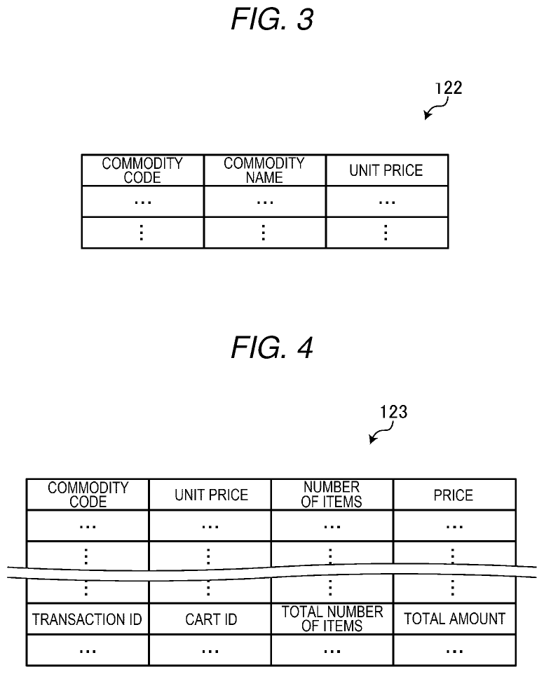

The commodity master 122 is a master file in which a commodity code for uniquely identifying a commodity sold in the store and commodity information of the commodity are stored correlation with each other. Note that a data structure of the commodity master 122 is explained in detail below (see FIG. 3).

The commodity registration file 123 is a file in which a commodity code and the like of a commodity, a code symbol of which a customer caused the scanner 18 to read, that is, a commodity that the customer plans to purchase are stored. Note that a data structure of the commodity registration file 123 is explained in detail below (see FIG. 4).

The control unit 11 is connected to a display device 16, an operation device 17, the scanner 18, and the camera 19 via the peripheral equipment controller 13 connected by the internal bus 15.

The display device 16 is a display device such as a liquid crystal monitor or an organic EL monitor included in the cart terminal 10. The display device 16 displays a commodity list and the like read by the scanner 18.

The operation device 17 is an information input device such as a touch panel stacked on the display device 16. When starting shopping, the customer presses an operation piece such as a shopping start button displayed on the display device 16, thereby instructing the cart terminal 10 to start shopping. After completing registering all commodities to be purchased, the customer presses an operation piece such as a checkout button displayed on the display device 16, thereby informing the cart terminal 10 that the commodity registration was completed.

The scanner 18 reads a code symbol such as a barcode held over a reading window. The scanner 18 is, for example, a barcode reader. The scanner 18 decodes the read code symbol and outputs a registered commodity code.

The camera 19 is an imaging apparatus that includes an imaging device such as a CCD or a CMOS and is installed to be able to image the entire basket 7. The camera 19 receives an imaging start instruction from the control unit 11 and starts imaging and receives an imaging end instruction from the control unit 11 and ends the imaging. The camera 19 images the basket 7 at speed of, for example, thirty frames per second. The camera 19 outputs a captured video to the edge gateway 20.

The communication I/F 14 causes the cart terminal 10 to perform wireless communication with the edge gateway 20 and the store server 30.

### Data Structure of the Commodity Master

A data structure of the commodity master 122 is explained with reference to FIG. 3. FIG. 3 is a diagram illustrating an example of the data structure of the commodity master.

The commodity master 122 stores a commodity name and a price, which are commodity information of a commodity, in association with a commodity code for uniquely specifying the commodity. Note that the commodity information may include information other than the above, for example, bargain information.

### Data Structure of the Commodity Registration File

A data structure of the commodity registration file 123 is explained with reference to FIG. 4. FIG. 4 is a diagram illustrating an example of the data structure of the commodity registration file.

The commodity registration file 123 stores a commodity code, a unit price, the number of items, a price for each commodity (tax exclusive) of a registered commodity. The commodity registration file 123 also stores a transaction ID, a cart ID, a total number of items of the commodity, and a total amount.

The transaction ID is an identification number for uniquely specifying a transaction. Since the transaction ID is issued by the store server 30 that acquired the commodity registration file 123, the transaction ID is blank at a point in time when the cart terminal 10 generated the commodity registration file 123. The transaction ID that the cart terminal 10 received from the store server 30 is stored in the field of the transaction ID.

The cart ID is an identification number for specifying the shopping cart 5 in which the cart terminal 10 that performed commodity registration is installed. The cart ID is the cart ID 124 stored in the storage unit 12 of the cart terminal 10 (see FIG. 2).

The total number of items of the commodity is a sum of the number of items of each commodity.

The total amount is a sum of prices for each commodity (tax exclusive). The sum of prices for each commodity (tax exclusive) and a consumption tax amount may be stored in the total amount.

### Hardware Configuration of an Edge Gateway

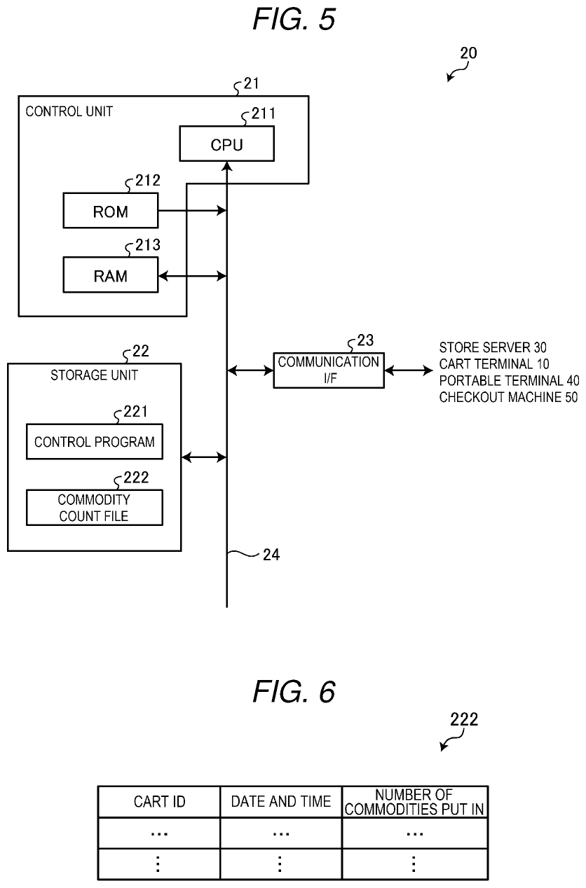

A hardware configuration of the edge gateway 20 is explained with reference to FIG. 5. FIG. 5 is a hardware block diagram illustrating an example of the hardware configuration of the edge gateway.

The edge gateway 20 includes a control unit 21, a storage unit 22, and a communication I/F 23.

The control unit 21 controls an operation of the entire edge gateway 20. The control unit 21 includes a CPU 211, a ROM 212, and a RAM 213. The CPU 211 is connected to the ROM 212 and the RAM 213 via an internal bus such as an address bus or a data bus. The CPU 211 loads, in the RAM 213, various programs stored in the ROM 212 and the storage unit 22. The CPU 211 operates according to the various programs loaded in the RAM 213 to control the operation of the edge gateway 20. That is, the control unit 21 has the configuration of the general computer.

The storage unit 22 is a storage device such as a HDD or an SSD connected to the control unit 11 via an internal bus 24. The storage unit 22 may be a nonvolatile memory such as a flash memory in which stored information is retained even if a power supply is turned off. The storage unit 22 stores a control program 221 and a commodity count file 222.

The control program 221 is a program for controlling the operation of the entire edge gateway 20. The control program 221 may be provided in a state in which the control program 221 is stored in the storage unit 22 or may be provided by being recorded in a computer-readable non-transitory recording medium such as a CD-ROM, a flexible disk, a CD-R, or a DVD as a file of an installable format or an executable format. The control program 221 may be stored on a computer connected to a network and provided by being downloaded through the network. Further, the control program 221 may be provided or distributed through a network such as the Internet.

The commodity count file 222 is a file in which a date and time when shopping was performed and the number of commodities put in the basket 7 of the shopping cart 5 are registered for each cart ID of the shopping cart 5. Note that a data structure of the commodity count file 222 is explained in detail below (see FIG. 6).

The communication I/F 23 causes the edge gateway 20 to perform wireless communication with the store server 30, the cart terminal 10, the portable terminal 40, and the checkout machine 50.

### Data Structure of the Commodity Count File

A data structure of the commodity count file 222 is explained with reference to FIG. 6. FIG. 6 is a diagram illustrating an example of the data structure of the commodity count file.

The commodity count file 222 stores a date and time and the number of commodities put in in correlation with a cart ID.

The cart ID is identification information of the shopping cart 5 transmitted in correlation with a video captured by the camera 19.

The date and time is a date and time when the camera 19 started imaging. Note that the date and time may further include a date and time when the camera 19 ended the imaging.

The number of commodities put in is the number of commodities (a first number) that the edge gateway 20 counted from a video captured by the camera 19 installed in the shopping cart 5 having the cart ID.

### Hardware Configuration of the Portable Terminal

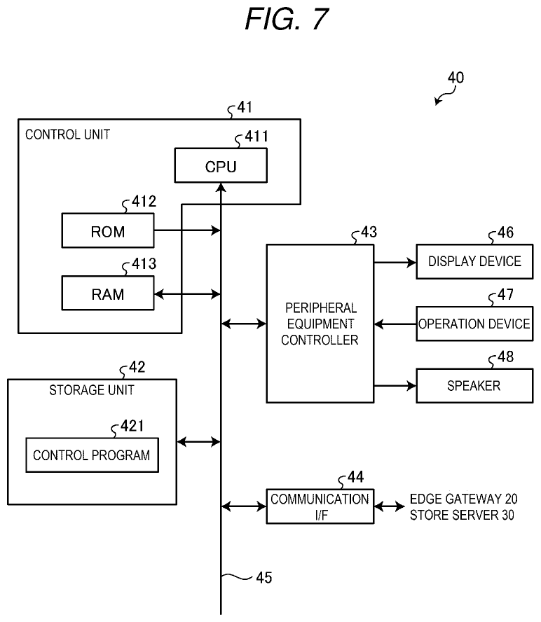

A hardware configuration of the portable terminal 40 is explained with reference to FIG. 7. FIG. 7 is a hardware block diagram illustrating an example of the hardware configuration of the portable terminal.

The portable terminal 40 includes a control unit 41, a storage unit 42, a peripheral equipment controller 43, and the communication I/F 23.

The control unit 41 controls an operation of the entire portable terminal 40. The control unit 41 includes a CPU 411, a ROM 412, and a RAM 413. The CPU 411 is connected to the ROM 412 and the RAM 413 via an internal bus such as an address bus or a data bus. The CPU 411 loads, in the RAM 413, various programs stored in the ROM 412 and the storage unit 42. The CPU 411 operates according to the various programs loaded in the RAM 413 to control the operation of the portable terminal 40. That is, the control unit 41 has the configuration of the general computer.

The storage unit 42 is a storage device such as a HDD or an SSD connected to the control unit 41 via an internal bus 45. The storage unit 42 may be a nonvolatile memory such as a flash memory in which stored information is retained even if a power supply is turned off. The storage unit 42 stores a control program 421.

The control program 421 is a program for controlling an operation of the entire portable terminal 40. The control program 421 may be provided in a state in which the control program 421 is stored in the storage unit 42 or may be provided by being recorded in a computer-readable non-transitory recording medium such as a CD-ROM, a flexible disk, a CD-R, or a DVD as a file of an installable format or an executable format. The control program 421 may be stored on a computer connected to a network and provided by being downloaded through the network. Further, the control program 421 may be provided or distributed through a network such as the Internet.

The control unit 41 is connected to a display device 46, an operation device 47, and a speaker 48 via a peripheral equipment controller 43 connected by the internal bus 45.

The display device 46 is a display device such as a liquid crystal monitor or an organic EL monitor included in the portable terminal 40. The display device 46 displays various kinds of information and the like transmitted from the store server 30 and the edge gateway 20.

The operation device 47 is an information input device such as a touch panel stacked on the display device 46. A store clerk carrying the portable terminal 40 operates the operation device 47 to thereby, for example, check information sent from the store server 30 and the edge gateway 20 and exchange information among store clerks.

The communication I/F 44 causes the portable terminal 40 to perform wireless communication with the edge gateway 20 and the store server 30.

### Hardware Configuration of the Checkout Machine

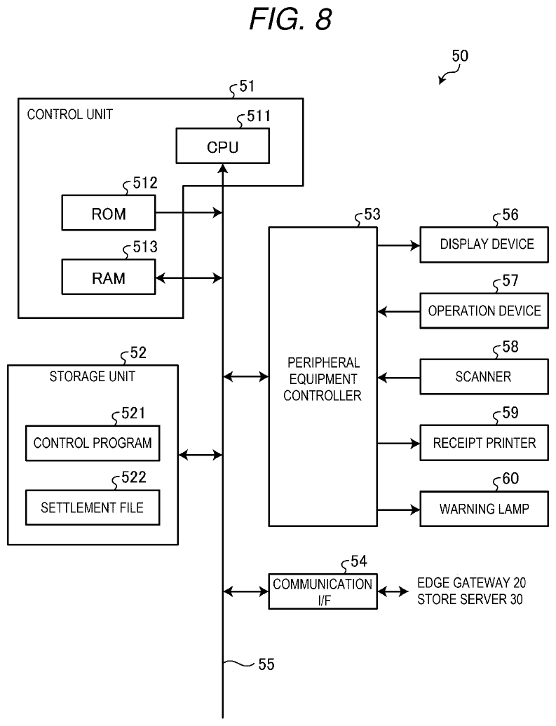

A hardware configuration of the checkout machine 50 is explained with reference to FIG. 8. FIG. 8 is a hardware block diagram illustrating an example of the hardware configuration of the checkout machine.

The checkout machine 50 includes a control unit 51, a storage unit 52, a peripheral equipment controller 53, and a communication I/F 54.

The control unit 51 controls an operation of the entire checkout machine 50. The control unit 51 includes a CPU 511, a ROM 512, and a RAM 513. The CPU 511 is connected to the ROM 512 and the RAM 513 via an internal bus such as an address bus or a data bus. The CPU 511 loads, in the RAM 513, various programs stored in the ROM 512 and the storage unit 52. The CPU 511 operates according to the various programs loaded in the RAM 513 to control the operation of the checkout machine 50. That is, the control unit 51 has the configuration of the general computer.

The storage unit 52 is a storage device such as a HDD or an SSD connected to the control unit 51 via an internal bus 55. The storage unit 52 may be a nonvolatile memory such as a flash memory in which stored information is retained even if a power supply is turned off. The storage unit 52 stores a control program 521 and a settlement file 522.

The control program 521 is a program for controlling the operation of the entire checkout machine 50. The control program 521 may be provided in a state in which the control program 521 is stored in the storage unit 52 or may be provided by being recorded in a computer-readable non-transitory recording medium such as a CD-ROM, a flexible disk (FD), a CD-R, or a DVD as a file of an installable format or an executable format. The control program 521 may be stored on a computer connected to a network and provided by being downloaded through the network. Further, the control program 521 may be provided or distributed through a network such as the Internet.

The settlement file 522 is a file in which settlement contents such as a settlement date and time, a settlement method, and a transaction amount are added to the content of the commodity registration file 123. The settlement file 522 is transmitted to, at predetermined timing, the store server 30 together with the identification number for uniquely specifying the checkout machine 50 and stored and managed as a sales file in the store server 30.

The control unit 51 is connected to a display device 56, an operation device 57, a scanner 58, and a receipt printer 59, and a warning lamp 60 via the peripheral equipment controller 53 connected by the internal bus 55.

The display device 56 is a display device such as a liquid crystal monitor or an organic EL monitor included in the checkout machine 50. The display device 56 displays various kinds of information relating to checkout processing.

The scanner 58 is, for example, a hand scanner and reads a code symbol including a transaction ID displayed on the display device 16 of the cart terminal 10.

The receipt printer 59 dispenses a receipt on which transaction content is printed.

The warning lamp 60 lights or flashes according to operation of a customer if the customer needs support of a store clerk. A store clerk noticing the lighting or the flashing of the warning lamp 60 rushes to the checkout machine 50 and supports the customer. Note that, instead of causing the warning lamp 60 to light or flash, the checkout machine 50 may transmit a signal requesting support to the portable terminal 40 carried by the store clerk.

Note that, although not illustrated in FIG. 8, the checkout machine 50 further includes a change machine and a card reader. If the customer performs cash settlement, the change machine receives payment of bills or coins and dispenses bills or coins as change. If the customer performs cashless settlement, the card reader reads information registered in a medium such as a credit card or an electronic money card.

The communication I/F 54 causes the checkout machine 50 to perform wireless communication with the edge gateway 20 and the store server 30.

### Functional Configuration of the Cart Terminal

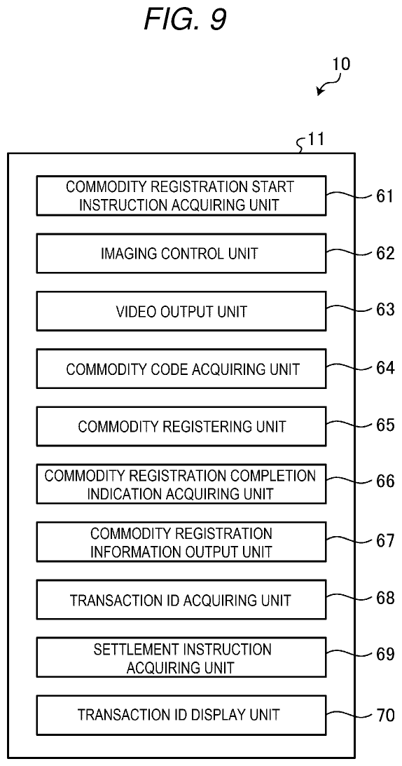

A functional configuration of the cart terminal 10 is explained with reference to FIG. 9. FIG. 9 is a functional block diagram illustrating an example of the functional configuration of the cart terminal.

The CPU 111 operates according to the control program 121 stored in the storage unit 12, whereby the control unit 11 of the cart terminal 10 functions as a commodity registration start indication acquiring unit 61, an imaging control unit 62, a video output unit 63, a commodity code acquiring unit 64, a commodity registering unit 65, a commodity registration completion indication acquiring unit 66, a commodity registration information output unit 67, a transaction ID acquiring unit 68, a settlement instruction acquiring unit 69, and a transaction ID display unit 70. Note that all or a part of these functions may be configured by hardware such as a dedicated circuit.

The commodity registration start indication acquiring unit 61 detects, with the operation device 17, that the shopping start button displayed on the display device 16 was pressed, thereby acquiring an indication that commodity registration was started.

The imaging control unit 62 instructs the camera 19 to start and end imaging.

The video output unit 63 outputs a video captured by the camera 19 and the cart ID 124 to the edge gateway 20 in correlation with each other.

The commodity code acquiring unit 64 reads a code symbol such as a barcode attached to a commodity held over the scanner 18 and acquires a commodity code registered in the code symbol.

The commodity registering unit 65 registers, in the commodity registration file 123, a commodity having the commodity code acquired by the commodity code acquiring unit 64.

The commodity registration completion indication acquiring unit 66 detects, with the operation device 17, that, for example, the checkout button displayed on the display device 16 and indicating that registration of the commodity was completed was pressed, thereby acquiring an indication that the commodity registration was completed.

The commodity registration information output unit 67 outputs the commodity registration file 123 to the edge gateway 20.

The transaction ID acquiring unit 68 acquires, from the edge gateway 20, a transaction ID given to the commodity registration file 123 by the store server 30. Note that the transaction ID acquiring unit 68 may acquire the transaction ID from the store server 30.

The settlement instruction acquiring unit 69 detects, with the operation device 17, that, for example, the settlement button displayed on the display device 16 and instructing to start settlement was pressed, thereby acquiring a settlement start instruction.

The transaction ID display unit 70 displays, in a form readable by the scanner 58 of the checkout machine 50, on the display device 16, a code symbol such as a barcode including the transaction ID.

### Functional Configuration of the Edge Gateway

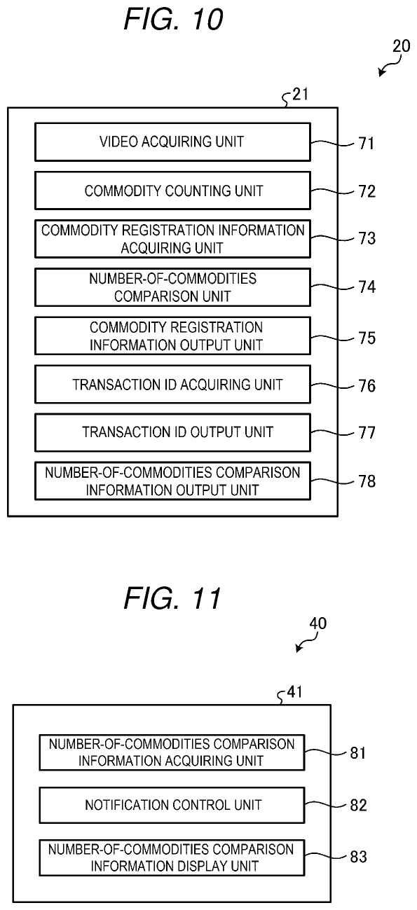

A functional configuration of the edge gateway 20 is explained with reference to FIG. 10. FIG. 10 is a functional block diagram illustrating an example of the functional configuration of the edge gateway.

The CPU 211 operates according to the control program 221 stored in the storage unit 22, whereby the control unit 21 of the edge gateway 20 functions as a video acquiring unit 71, a commodity counting unit 72, a commodity registration information acquiring unit 73, a number-of-commodities comparing unit 74, a commodity registration information output unit 75, a transaction ID acquiring unit 76, a transaction ID output unit 77, and a number-of-commodities comparison information output unit 78. Note that all or a part of these functions may be configured by hardware such as a dedicated circuit.

The video acquiring unit 71 acquires, from the cart terminal 10, a video of a commodity being put in the basket 7 captured by the camera 19 that images the basket 7 of the shopping cart 5 and a camera ID for identifying the shopping cart 5.

The commodity counting unit 72 counts, from the video acquired by the video acquiring unit 71, a first number that is the number of commodities put in the basket 7. Note that the commodity counting unit 72 is an example of the counting unit in the present disclosure. The commodity counting unit 72 performs image processing such as well-known skeleton estimation, thereby recognizing the positions of an arm and a hand of a customer. Further, the commodity counting unit 72 recognizes that the hand of the customer is present above the basket 7 and an object left (separated from) the hand, thereby determining that the customer put a commodity in the basket 7. The commodity counting unit 72 counts the number of commodities put in the basket 7. Alternatively, the commodity counting unit 72 may acquire a video of the inside of the basket 7 captured by the camera 19 and recognize the number of commodities present on the inside of the basket 7 using an object recognition technique.

The commodity registration information acquiring unit 73 acquires a second number that is the number of commodities read by the scanner 18 of the cart terminal 10 until registration completion. More specifically, the commodity registration information acquiring unit 73 acquires the commodity registration file 123 from the cart terminal 10. Note that the commodity registration information acquiring unit 73 is an example of the number-of-commodities acquiring unit in the present disclosure.

The number-of-commodities comparing unit 74 compares the first number counted by the number-of-commodities counting unit 72 and the second number that is the number of commodities registered in the commodity registration file 123.

The commodity registration information output unit 75 outputs, on condition that the first number and the second number do not match, the identification number of the shopping cart 5 (the basket 7), the first number, and the second number in order to cause the portable terminal 40 carried by a store clerk to alert the store clerk.

The transaction ID acquiring unit 76 acquires, from the store server 30, a transaction ID given by the store server 30 to the commodity registration file 123 output to the store server 30 by the edge gateway 20.

The transaction ID output unit 77 outputs the transaction ID acquired from the store server 30 to the cart terminal 10 corresponding to the transaction ID.

The number-of-commodities comparison information output unit 78 outputs, on condition that the first number and the second number do not match, the cart ID for identifying the shopping cart 5, the first number, and the second number to the portable terminal 40 carried by the store clerk and causes the portable terminal 40 to alert the store clerk. Note that the number-of-commodities comparison information output unit 78 may output the cart ID, the first number, and the commodity registration file 123 to the portable terminal 40. The number-of-commodities comparison information output unit 78 outputs these kinds of information to all the portable terminals 40.

### Functional Configuration of the Portable Terminal

A functional configuration of the portable terminal 40 is explained with reference to FIG. 11. FIG. 11 is a functional block diagram illustrating an example of the functional configuration of the portable terminal.

The CPU 411 operates according to the control program 421 stored in the storage unit 42, whereby the control unit 41 of the portable terminal 40 functions as a number-of-commodities comparison information acquiring unit 81, an alert control unit 82, and a number-of-commodities comparison information display unit 83. Note that all or a part of these functions may be configured by hardware such as a dedicated circuit.

The number-of-commodities comparison information acquiring unit 81 acquires, from the edge gateway 20, the cart ID for identifying the shopping cart 5, the first number, and the second number. The number-of-commodities comparison information acquiring unit 81 may acquire the cart ID, the first number, and the commodity registration file 123 from the edge gateway 20. Note that the number-of-commodities comparison information acquiring unit 81 acquires these kinds of information only if the first number and the second number do not match.

The alert control unit 82 alerts the store clerk on condition that the number-of-commodities comparison information acquiring unit 81 acquired the cart ID, the first number, and the second number from the edge gateway 20. A method of the alert does not matter. For example, the alert control unit 82 outputs warning sound from the speaker 48 of the portable terminal 40. Alternatively, the portable terminal 40 may cause a not-illustrated oscillator (vibrator) included in the portable terminal 40 to oscillate.

The number-of-commodities comparison information display unit 83 displays the information acquired by the number-of-commodities comparison information acquiring unit 81 on the display device 46 included in the portable terminal 40.

### Functional Configuration of the Checkout Machine

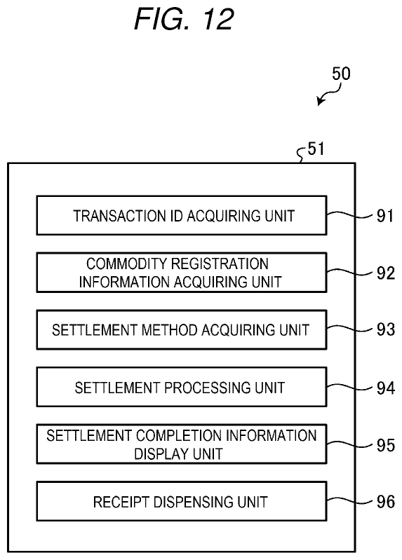

A functional configuration of the checkout machine 50 is explained with reference to FIG. 12. FIG. 12 is a functional block diagram illustrating an example of the functional configuration of the checkout machine.

The CPU 511 operates according to the control program 521 stored in the storage unit 52, whereby the control unit 51 of the checkout machine 50 functions as a transaction ID acquiring unit 91, a commodity registration information acquiring unit 92, a settlement method acquiring unit 93, a settlement processing unit 94, a settlement completion information display unit 95, and a receipt dispensing unit 96. Note that all or a part of these functions may be configured by hardware such as a dedicated circuit.

The transaction ID acquiring unit 91 reads, with the scanner 58 included in the checkout machine 50, a code symbol including a transaction ID displayed on the display device 16 of the cart terminal 10 to acquire the transaction ID.

The commodity registration information acquiring unit 92 outputs the transaction ID acquired by the transaction ID acquiring unit 91 to the store server 30 and acquires a commodity registration file corresponding to the transaction ID from the store server 30.

The settlement method acquiring unit 93 detects, with the operation device 57, which of selection buttons for selecting a settlement method displayed on the display device 56 of the checkout machine 50 was pressed, thereby acquiring a settlement method instructed by a customer.

The settlement processing unit 94 performs settlement with the settlement method acquired by the settlement method acquiring unit 93. If cash settlement was selected, the settlement processing unit 94 receives cash with the change machine included in the checkout machine 50. If cashless settlement was selected, the settlement processing unit 94 reads, with the card reader included in the checkout machine 50, according to the settlement method, registration information of a credit card of the customer, a charge amount of an electronic money card of the customer, or the like and causes a not-illustrated external server, which performs settlement processing, to perform settlement.

The settlement completion information display unit 95 displays, on the display device 56 of the checkout machine 50, information indicating that the settlement was completed and transaction content.

The receipt dispensing unit 96 dispenses, from the receipt printer 59 included in the checkout machine 50, a receipt on which settlement content is printed.

### Hardware Configuration and Functional Configuration of the Store Server

Although a hardware configuration and a functional configuration of the store server 30 are not illustrated, like the edge gateway 20, the store server 30 has the configuration of the general computer.

The store server 30 transmits, to the cart terminal 10, a commodity master that is updated at any time. The store server 30 acquires the commodity registration file 123 from the cart terminal 10, issues a transaction ID, and notifies the issued transaction ID to the cart terminal 10. Note that the store server 30 issues the transaction ID only if the number of commodities (the first number) counted by the edge gateway 20 and the number of commodities (the second number) registered in the commodity registration file 123 match. Therefore, only if it is determined that the first number and the second number are equal, the edge gateway 20 may output, to the store server 30, the commodity registration file 123 acquired from the cart terminal 10.

The store server 30 issues, to the commodity registration file 123, a transaction ID for uniquely specifying the commodity registration file 123 and correlates the transaction ID with the commodity registration file 123.

### Flow of Processing Performed by the Cart Terminal

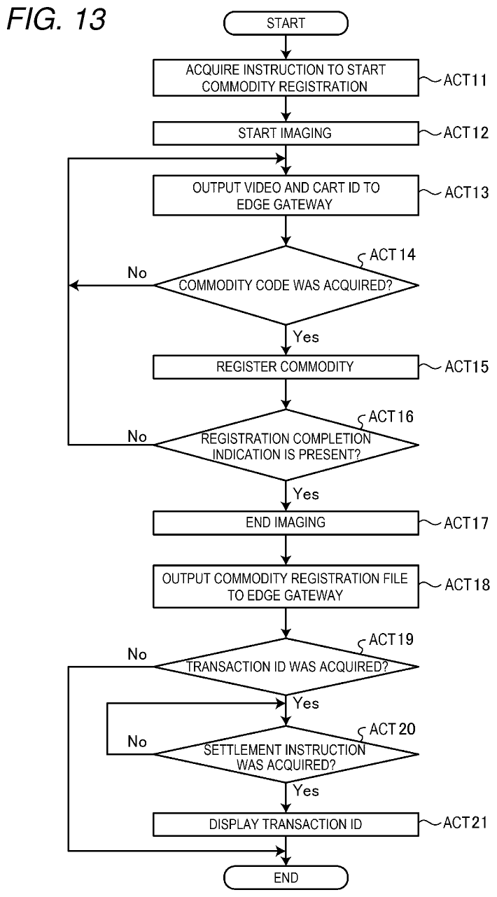

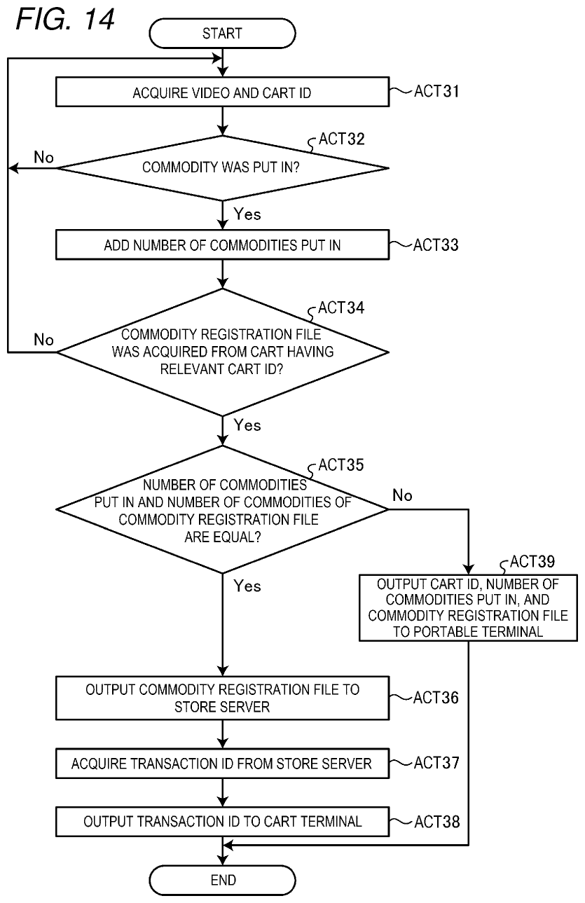

A flow of processing performed by the cart terminal 10 is explained with reference to FIG. 13. FIG. 13 is a flowchart illustrating an example of the flow of the processing performed by the cart terminal.

The commodity registration start indication acquiring unit 61 detects, with the operation device 17, that the shopping start button displayed on the display device 16, thereby acquiring an indication that commodity registration was started (Act 11).

The imaging control unit 62 causes the camera 19 to start capturing a video (Act 12).

The video output unit 63 outputs the video captured by the camera 19 and the cart ID 124 to the edge gateway 20 in correlation with each other (Act 13).

The commodity code acquiring unit 64 determines whether a commodity code was acquired from a code symbol read by the scanner 18 (Act 14). If it is determined that a commodity code was acquired (Yes in Act 14), the processing proceeds to Act 15. On the other hand, if it is not determined that a commodity code was acquired (No in Act 14), the processing returns to Act 13.

If it is determined in Act 14 that a commodity code was acquired, the commodity registering unit 65 registers a commodity having the commodity code acquired by the commodity code acquiring unit 64 in the commodity registration file 123 (Act 15).

The commodity registration completion indication acquiring unit 66 determines whether an indication that the commodity registration was completed is present (Act 16). If it is determined that an indication that the commodity registration was completed is present (Yes in Act 16), the processing proceeds to Act 17. On the other hand, if it is not determined that an indication that the commodity registration was completed is present (No in Act 16), the processing returns to Act 13. Note that the commodity registration completion indication acquiring unit 66 detects, with the operation device 17, that the checkout button displayed on the display device 16 was pressed, thereby determining that indication an that the commodity registration was completed is present.

If it is determined in Act 16 that an indication that the commodity registration was completed is present, the imaging control unit 62 instructs the camera 19 to end the imaging (Act 17). Note that, although not described in the flowchart of FIG. 13, at this time, the video output unit 63 ends outputting the video to the edge gateway 20.

The commodity registration information output unit 67 outputs the commodity registration file 123 to the edge gateway 20 (Act 18).

The transaction ID acquiring unit 68 determines whether the transaction ID given to the commodity registration file 123 by the store server 30 was acquired from the edge gateway 20 (Act 19). If it is determined that the transaction ID was acquired (Yes in Act 19), the processing proceeds to Act 20. On the other hand, if it is not determined that the transaction ID was acquired (No in Act 19), the cart terminal 10 ends the processing. Note that the transaction ID acquiring unit 68 may acquire a transaction ID from the store server 30.

If it is determined in Act 19 that the transaction ID was acquired, the settlement instruction acquiring unit 69 determines whether a settlement start instruction was acquired from a customer (Act 20). If it is determined that a settlement start instruction was acquired from the customer (Yes in Act 20), the processing proceeds to Act 21. On the other hand, if it is not determined that a settlement start instruction was acquired from the customer (No in Act 20), Act 20 is repeated. Note that the settlement instruction acquiring unit 69 detects, with the operation device 17, that, for example, the settlement button displayed on the display device 16 was pressed, thereby determining that a settlement start was instructed.

If it is determined in Act 20 that a settlement start instruction was acquired from the customer, the transaction ID display unit 70 displays a code symbol such as a barcode including the transaction ID on the display device 16 in a form readable by the scanner 58 of the checkout machine 50 (Act 21). Thereafter, the cart terminal 10 ends the processing.

### Flow of Processing Performed by the Edge Gateway

A flow of processing performed by the edge gateway 20 is explained with reference to FIG. 14. FIG. 14 is a flowchart illustrating an example of the flow of the processing performed by the edge gateway.

The video acquiring unit 71 acquires, from the cart terminal 10, a video captured by the camera 19 and the cart ID 124 (Act 31).

The commodity counting unit 72 analyzes the video acquired by the video acquiring unit 71 and determines whether a commodity was put in the basket 7 (Act 32). If it is determined that a commodity was put in the basket 7 (Yes in Act 32), the processing proceeds to Act 33. On the other hand, if it is not determined that a commodity was put in the basket 7 (No in Act 32), the processing returns to Act 31. Note that the commodity counting unit 72 determines whether a commodity was put in the basket 7 by, for example, recognizing that an object separated from an arm and a hand of a customer detected by skeleton detection toward the basket 7.

If it is determined in Act 32 that a commodity was put in the basket 7, the commodity counting unit 72 adds the number of commodities put in the basket 7 having the relevant cart ID (Act 33).

The commodity registration information acquiring unit 73 determines whether the commodity registration file 123 was acquired from the cart terminal 10 installed in the shopping cart 5 having the relevant cart ID (Act 34). If it is determined that the commodity registration file 123 was acquired (Yes in Act 34), the processing proceeds to Act 35. On the other hand, if it is not determined that the commodity registration file 123 was not acquired (No in Act 34), the processing returns to Act 31.

If it is determined in Act 34 that the commodity registration file 123 was acquired, the number-of-commodities comparing unit 74 determines whether the number of commodities counted by the commodity counting unit 72 (the number of commodities put in the basket 7) and the number of commodities registered in the commodity registration file 123 are equal (Act 35). If it is determined that the numbers of commodities are equal (Yes in Act 35), the processing proceeds to Act 36. On the other hand, if it is not determined that the numbers of commodities are equal (No in Act 35), the processing proceeds to Act 39.

If it is determined in Act 35 that the number of commodities put in the basket 7 and the number of commodities registered in the commodity registration file 123 are equal, the commodity registration information output unit 75 outputs the commodity registration file 123 to the store server 30 (Act 36).

The transaction ID acquiring unit 76 acquires, from the store server 30, a transaction ID that the store server 30 gave to the commodity registration file 123 output in Act 36 (Act 37).

The transaction ID output unit 77 outputs the transaction ID acquired in Act 37 by the transaction ID acquiring unit 76 to the cart terminal 10 (Act 38). Thereafter, the edge gateway 20 ends the processing.

Referring back to Act 35, if it is not determined in Act 35 that the number of commodities put in the basket 7 and the number of commodities registered in the commodity registration file 123 are equal, the number-of-commodities comparison information output unit 78 outputs the cart ID, the number of commodities put in and the commodity registration file 123 to the portable terminal 40 (Act 39). Thereafter, the edge gateway 20 ends the processing.

### Flow of Processing Performed by the Portable Terminal

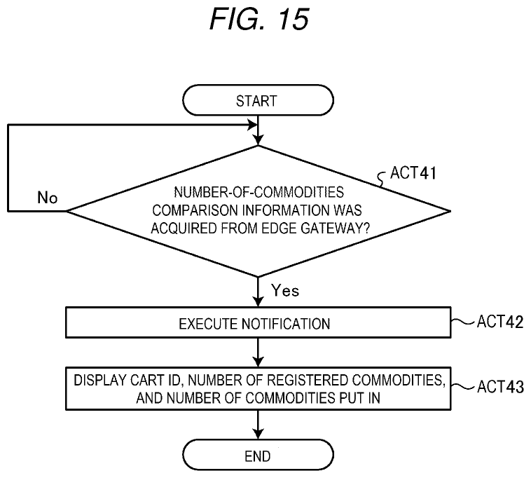

A flow of processing performed by the portable terminal 40 is explained with reference to FIG. 15. FIG. 15 is a flowchart illustrating an example of the flow of the processing performed by the portable terminal.

The number-of-commodities comparison information acquiring unit 81 determines whether number-of-commodities comparison information output by the number-of-commodities comparison information output unit 78 was acquired from the edge gateway 20 (Act 41). Note that the number-of-commodities comparison information is information including a cart ID, a first number, and a second number output by the edge gateway 20 on condition that the first number and the second number do not match. If it is determined that the number-of-commodities comparison information was acquired (Yes in Act 41), the processing proceeds to Act 42. On the other hand, if it is not determined that the number-of-commodities comparison information was acquired (No in Act 41), Act 41 is repeated.

If it is determined in Act 41 that the number-of-commodities comparison information was acquired, the alert control unit 82 causes the speaker 48 included in the portable terminal 40 to output sound or voice, thereby alerting a store clerk (Act 42).

The number-of-commodities comparison information display unit 83 displays the information acquired by the number-of-commodities comparison information acquiring unit 81 on the display device 46 included in the portable terminal 40 (Act 43). Thereafter, the portable terminal 40 ends the processing.

Among store clerks carrying the portable terminals 40 that received the alert, a store clerk who can rush to a place of the shopping cart 5 having the notified cart ID goes to the place of the shopping cart 5, obtains a customer's consent for commodity check, and checks whether a commodity put in the basket 7 matches a registered commodity.

### Flow of Processing Performed by the Checkout Machine

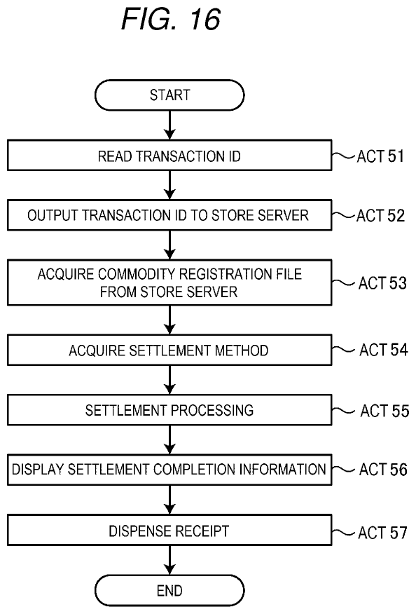

A flow of processing performed by the checkout machine 50 is explained with reference to FIG. 16. FIG. 16 is a flowchart illustrating an example of the flow of the processing performed by the checkout machine.

The transaction ID acquiring unit 91 reads, with the scanner 58 included in the checkout machine 50, a code symbol including a transaction ID displayed on the display device 16 of the cart terminal 10 to acquire the transaction ID (Act 51).

The commodity registration information acquiring unit 92 outputs the transaction ID acquired by the transaction ID acquiring unit 91 to the store server 30 (Act 52).

The commodity registration information acquiring unit 92 acquires, from the store server 30, the commodity registration file 123 corresponding to the transaction ID (Act 53).

The settlement method acquiring unit 93 detects, with the operation device 57, which of the selection buttons for selecting a settlement method displayed on the display device 56 of the checkout machine 50 was pressed, thereby acquiring a settlement method instructed by a customer (Act 54).

The settlement processing unit 94 performs settlement processing corresponding to the settlement method acquired in Act 54 (Act 55).

The settlement completion information display unit 95 displays, on the display device 56 of the checkout machine 50, information indicating that settlement was completed and transaction content (Act 56).

The receipt dispensing unit 96 dispenses, from the receipt printer 59 included in the checkout machine 50, a receipt on which settlement content is printed (Act 57). Thereafter, the checkout machine 50 ends the processing.

Note that, although not illustrated in the flowchart of FIG. 16, after the settlement processing was completed, the checkout machine 50 generates the settlement file 522 indicating settlement content and outputs the settlement file 522 to the store server 30.

### Action Effects of the First Embodiment

As explained above, the edge gateway 20 (the commodity registration support apparatus) included in the commodity sales data processing system 1 in the first embodiment reads information for uniquely specifying a commodity to be purchased, thereby supporting an operation of the cart terminal 10 (the commodity registration apparatus) that registers the commodity. The edge gateway 20 includes the video acquiring unit 71 that acquires a video of the commodity being put in the basket 7 (the storing unit) captured by the camera 19 (the imaging apparatus) that images the basket 7 that stores the commodity, the information of which was read, and an identification number for identifying the basket 7, the commodity counting unit 72 (the counting unit) that counts, from the video acquired by the video acquiring unit 71, a first number that is the number of commodities put in the basket 7, the commodity registration information acquiring unit 73 (the number-of-commodities acquiring unit) that acquires a second number that is the number of commodities read by the scanner 18 until registration completion, and the number-of-commodities comparison information output unit 78 that outputs, on condition that the first number and the second number do not match, the identification number for identifying the basket 7, the first number, and the second number in order to cause the portable terminal 40 (the terminal apparatus) carried by a store clerk to alert the store clerk. Therefore, without adding substantial remodeling to the shopping cart of the related art, a customer is enabled to perform commodity registration by himself or herself. Further, since a state in which the customer puts a commodity in the basket 7 of the shopping cart 5 is monitored and the number of commodities put in the basket 7 is counted, it is possible to securely find a fraudulent act of the customer putting a commodity in the basket 7 without reading a code symbol and alert the store clerk.

In the edge gateway 20 (the commodity registration support apparatus) included in the commodity sales data processing system 1 in the first embodiment, the video acquiring unit 71 acquires a video captured by the camera 19 (the imaging apparatus) for a period from when a commodity registration start was instructed to the cart terminal 10 (the commodity registration apparatus) until when commodity registration completion was indicated. Therefore, it is possible to thoroughly image a state in which the customer puts a commodity in the basket 7 of the shopping cart 5.

In the commodity sales data processing system 1 in the first embodiment, if the first number and the second number do not match, the first number and the second number are notified to the portable terminal 40 (the terminal apparatus) carried by the store clerk. Therefore, it is possible to thoroughly inform the store clerk that the first number, which is the number of commodities that the customer put in the basket 7 of the shopping cart 5, and the second number, which is the number of commodities read by the scanner 18 until registration completion, are different. Accordingly, a store clerk present near the relevant shopping cart 5 can immediately rush to the shopping cart 5 and support the customer.

The commodity sales data processing system 1 in the first embodiment includes the scanner 18 that is installed in the shopping cart 5 and reads a code symbol attached to a commodity and including an identification number of the commodity, the camera 19 (the imaging apparatus) that is installed in the shopping cart 5 and captures a video of the commodity, the code symbol of which was read, being put in the basket 7 (the storing unit) of the shopping cart 5, the edge gateway 20 (the commodity registration support apparatus) that acquires the video and an identification number of the shopping cart 5, counts a first number that is the number of commodities put in the shopping cart 5, acquires a second number that is the number of commodities read by the scanner 18 until registration completion, and outputs the identification number of the shopping cart 5, the first number, and the second number on condition that the first number and the second number do not match, the portable terminal 40 (the terminal apparatus) that is carried by a store clerk and alerts the store clerk on condition that the identification number of the shopping cart 5, the first number, and the second number output by the edge gateway 20 were acquired, the cart terminal 10 (the commodity registration apparatus) that registers a commodity scanned by the scanner 18, and the checkout machine 50 (the checkout apparatus) that performs settlement processing relating to the commodity registered by the cart terminal 10. Therefore, without adding substantial remodeling to the shopping cart of the related art, a customer is enabled to perform commodity registration by himself or herself. Further, since a state in which the customer puts a commodity in the basket 7 of the shopping cart 5 is monitored and the number of commodities put in the basket 7 is counted, it is possible to prevent a fraudulent act of the customer putting a commodity in the basket 7 without reading a code symbol.

### Second Embodiment

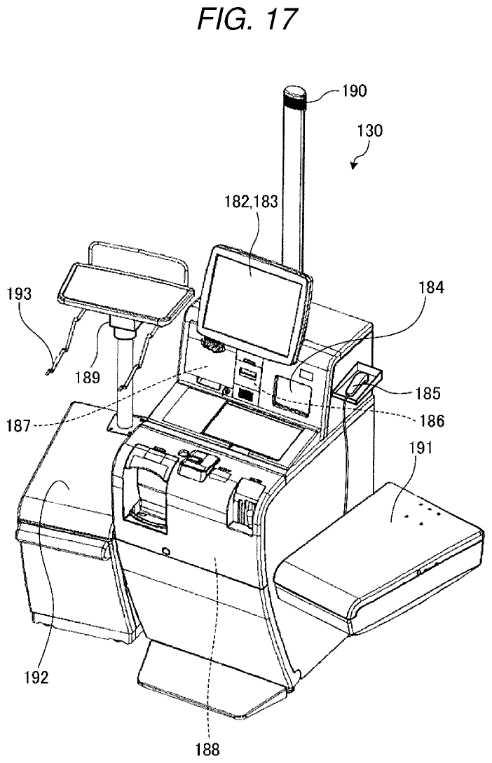

Next, a second embodiment of the present disclosure is explained. In a not-illustrated commodity sales data processing system 2 according to the second embodiment, the shopping cart 5 does not include the cart terminal 10, the scanner 18, and the camera 19 in the commodity sales data processing system 1 illustrated in FIG. 1. The commodity sales data processing system 2 includes a self-service POS terminal 130 illustrated in FIG. 17 instead of the checkout machine 50 illustrated in FIG. 1.

A customer does shopping while walking and pushing the shopping cart 5 or carrying a not-illustrated basket and while putting commodities in the basket 7 of the shopping cart 5 or the carried basket. The customer having finished the shopping performs, with the self-service POS terminal 130, registration and checkout for the commodities to be purchased. That is, the self-service POS terminal 130 has both of the function of the cart terminal 10 and the function of the checkout machine 50 in the first embodiment.

A camera 189 (see FIG. 17) explained below is installed in the self-service POS terminal 130. The camera 189 captures a video of the customer putting a commodity, a code symbol of which the customer caused a scanner 184 (see FIG. 17) to read, (that is, a registered commodity) in the basket.

The self-service POS terminal 130 transmits, to the edge gateway 20, the video captured by the camera 189 and a commodity registration file that stores commodity information registered by the self-service POS terminal 130.

The edge gateway 20 has the same function as the function explained in the first embodiment. That is, the edge gateway 20 analyzes the video captured by the camera 189, thereby counting the number of commodities that the customer put in the basket. The edge gateway 20 compares the number of commodities that the customer put in the basket (that is, the first number in the first embodiment) and the number of commodities registered in the commodity registration file (that is, the second number in the first embodiment). If the first number and the second number do not match, the edge gateway 20 transmits information indicating to that effect to the self-service POS terminal 130.

If receiving, from the edge gateway 20, the information indicating that the first number and the second number do not match, the self-service POS terminal 130 causes a warning lamp 190 (see FIG. 17) included in the self-service POS terminal 130 to light or flash, thereby alerting a store clerk present near the self-service POS terminal 130. The store clerk noticing the alert goes to the customer operating the self-service POS terminal 130, explains the situation to the customer, and, for example, checks the commodity. Note that the self-service POS terminal 130 is an example of the terminal apparatus in the present disclosure.

### Schematic of Configuration the Self-Service POS Terminal

A schematic configuration of the self-service POS terminal 130 is explained with reference to FIG. 17. FIG. 17 is a schematic perspective view of the self-service POS terminal included in the commodity sales data processing system in the second embodiment.

The self-service POS terminal 130 includes a display device 182, a scanner 184, and a hand scanner 185. An operation device 183 is stacked on the surface of the display device 182.

The display device 182 is, for example, a liquid crystal monitor or an organic EL monitor. The display device 182 displays various kinds of information relating to a commodity transaction to a customer. For example, the display device 182 displays commodity information registered by reading, with the scanner 184 or the hand scanner 185, a code symbol attached to a commodity. The display device 182 displays a total amount of the commodity, a deposit amount, a change amount, and the like and displays, for example, a checkout screen (not illustrated) for causing the customer to select a payment method.

The customer checks the information displayed on the display device 182 and, if necessary, proceeds with registration and settlement for the commodity while operating operation buttons displayed on the screen. At that time, the operation of the operation buttons by the customer is detected by the operation device 183 configured by, for example, a touch panel and communicated to the self-service POS terminal 130.

The scanner 184 and the hand scanner 185 read a code symbol such as a barcode or a two-dimensional code attached to the commodity. The scanner 184 and the hand scanner 185 include an optical imaging element such as a CCD (Charge Coupled Device) or a CMOS (Complementary Metal Oxide Semiconductor) and images an imaging region in front of a reading window. The customer holds the code symbol attached to the commodity over the reading window of the scanner 184 to cause the scanner 184 to read the code symbol. Concerning a large commodity such as a cardboard box or a long commodity, it is difficult to hold a code symbol attached to the commodity over the reading window of the scanner 184. In such a case, the customer holds the hand scanner 185 over the code symbol such as a barcode attached to the commodity, thereby causing the hand scanner 185 to read the code symbol.

On the right side facing the self-service POS terminal 130, a commodity placing table 191 on which the customer places unsettled commodities put in a basket is provided. On the left side facing the self-service POS terminal 130, a commodity placing table 192 on which the customer places settled commodities is provided. The customer puts registered commodities in a basket placed on the commodity placing table 192. If the customer prepared a bag-like reusable shopping bag, the customer hangs a grip of the bag on a hook 193 provided above the commodity placing table 192 and puts the registered commodities in the bag.

Above the commodity placing table 192, the camera 189 is installed downward. The camera 189 images a state in which the customer puts the registered commodities in the basket placed on the commodity placing table 192 or the bag, the grip of which is hung on the hook 193. The self-service POS terminal 130 transmits a captured video to the edge gateway 20 in association with an identification number for uniquely specifying the self-service POS terminal 130.

The self-service POS terminal 130 further includes a card reader 186. The card reader 186 reads a point card, a credit card, or the like of the customer inserted into the card reader 186. The self-service POS terminal 130 includes a receipt printer 187. If settlement is completed, the receipt printer 187 dispenses a receipt on which a transaction result is printed.

The self-service POS terminal 130 includes a change machine 188 that calculates an amount of bills and coins deposited by the customer at the settlement time and dispenses change bills and change coins if necessary.

Further, the warning lamp 190 is installed at the distal end of a pole provided above the self-service POS terminal 130. The warning lamp 190 lights or flashes if an abnormality occurs in operation performed in the self-service POS terminal 130, if an abnormality occurs in an operation of the self-service POS terminal 130, or if a store clerk is called. If information indicating that the number of commodities that the customer put in the basket and the number of commodities read by the scanner 184 or the hand scanner 185 do not match is received from the edge gateway 20, the warning lamp 190 lights or flashes to thereby alert the store clerk.

### Hardware Configuration of the Self-Service POS Terminal

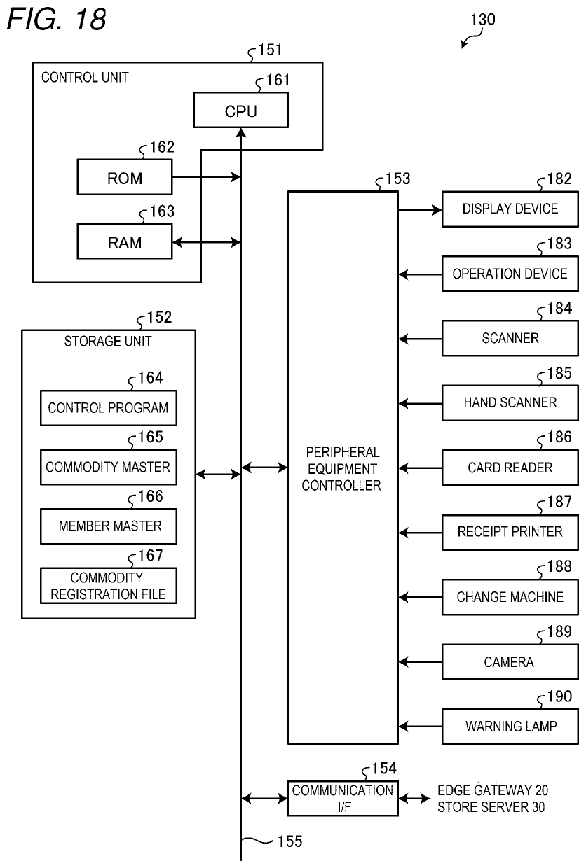

A hardware configuration of the self-service POS terminal 130 is explained with reference to FIG. 18. FIG. 18 is a hardware block diagram illustrating an example of the hardware configuration of the self-service POS terminal.

The self-service POS terminal 130 includes a control unit 151, a storage unit 152, a peripheral equipment controller 153, and a communication I/F 154.

The control unit 151 controls an operation of the entire self-service POS terminal 130. The control unit 151 includes a CPU 161, a ROM 162, and a RAM 163. The CPU 161 is connected to the ROM 162 and the RAM 163 via an internal bus such as an address bus or a data bus. The CPU 161 loads, in the RAM 163, various programs stored in the ROM 162 and the storage unit 152. The CPU 161 operates according to the various programs loaded in the RAM 163 to control the operation of the self-service POS terminal 130. That is, the control unit 151 has the configuration of the general computer.

The storage unit 152 is a storage device such as a HDD or an SDD connected to the control unit 151 via an internal bus 155. The storage unit 152 may be a nonvolatile memory such as a flash memory in which stored information is retained even if a power supply is turned off. The storage unit 152 stores a control program 164, a commodity master 165, a member master 166, and a commodity registration file 167.

The control program 164 is a program for controlling the operation of the entire self-service POS terminal 130. The control program 164 may be provided in a state in which the control program 164 is stored in the storage unit 152 or may be provided by being recorded in a computer-readable non-transitory recording medium such as a CD-ROM, a flexible disk (FD), a CD-R, or a DVD as a file of an installable format or an executable format. The control program 164 may be stored on a computer connected to a network and provided by being downloaded through the network. Further, the control program 164 may be provided or distributed through a network such as the Internet.

The commodity master 165 is the same as the commodity master 122 explained above (see FIG. 3).

The member master 166 is a master file in which a name, a date of birth, sex, nationality, a mail address of a portable terminal, and the like of a customer are stored in correlation with a member ID of the customer. The member master 166 reads, based on a member ID read from a member card by the card reader 186, information concerning a customer owning the member card and updates a purchase history and the like of the customer. The purchase history is used to improve the quality of a service to the customer.

The commodity registration file 167 is the same as the commodity registration file 123 explained above (see FIG. 4).

The control unit 151 is connected to various kinds of peripheral equipment illustrated in FIG. 18 via the peripheral equipment controller 153 connected by the internal bus 155. All of overviews of these kinds of peripheral equipment are as explained above. Therefore, redundant explanation of the overview of the peripheral equipment is omitted.

The communication I/F 154 causes the self-service POS terminal 130 to perform wireless communication with the edge gateway 20 and the store server 30.

### Functional Configuration of the Self-Service POS Terminal

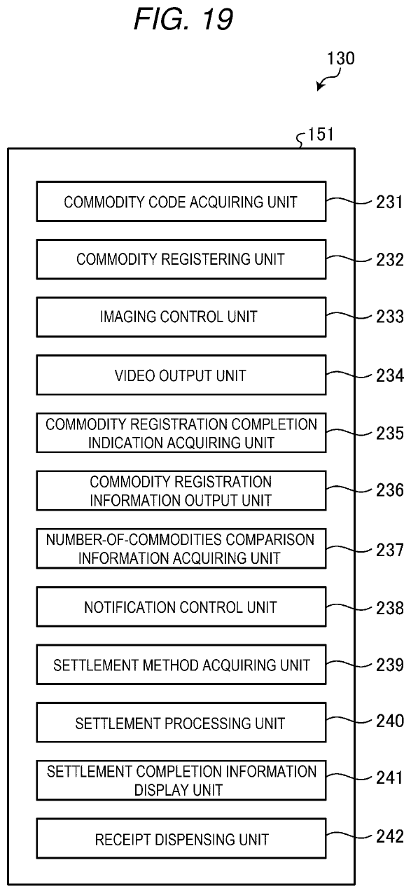

A functional configuration of the self-service POS terminal 130 is explained with reference to FIG. 19. FIG. 19 is a functional block diagram illustrating an example of the functional configuration of the self-service POS terminal.

The CPU 161 operates according to the control program 164 stored in the storage unit 152, whereby the control unit 151 of the self-service POS terminal 130 functions as a commodity code acquiring unit 231, a commodity registering unit 232, an imaging control unit 233, a video output unit 234, a commodity registration completion indication acquiring unit 235, a commodity registration information output unit 236, a number-of-commodities comparison information acquiring unit 237, an alert control unit 238, a settlement method acquiring unit 239, a settlement processing unit 240, a settlement completion information display unit 241, and a receipt dispensing unit 242. Note that all or a part of these functions may be configured by hardware such as a dedicated circuit.

The commodity code acquiring unit 231 reads a code symbol such as a barcode attached to a commodity held over the scanner 184 or the hand scanner 185 and acquires a commodity code registered in the code symbol.

The commodity registering unit 232 registers, in the commodity registration file 167, a commodity having the commodity code acquired by the commodity code acquiring unit 231.

The imaging control unit 233 instructs the camera 189 to start and end imaging.

The video output unit 234 outputs a video captured by the camera 189 and the identification number for uniquely specifying the self-service POS terminal 130 to the edge gateway 20 in correlation with each other.

The commodity registration completion indication acquiring unit 235 detects, with the operation device 183, that, for example, a checkout button displayed on the display device 182 and indicating that registration of a commodity was completed was pressed, thereby acquiring an indication that the commodity registration was completed.

The commodity registration information output unit 236 outputs the commodity registration file 167 to the edge gateway 20.

The number-of-commodities comparison information acquiring unit 237 acquires, from the edge gateway 20, a video transmitted from the self-service POS terminal 130 including the number-of-commodities comparison information acquiring unit 237 and a first number (the number of commodities put in a basket) and a second number (the number of commodities registered in the commodity registration file 167) based on the commodity registration file 167, that is, number-of-commodities comparison information. Note that, only if the first number and the second number do not match, the edge gateway 20 outputs these kinds of information to the self-service POS terminal 130.

The alert control unit 238 causes the warning lamp 190 to light or flash, thereby alerting a store clerk on condition that the number-of-commodities comparison information acquiring unit 237 acquired the first number and the second number from the edge gateway 20.

The settlement method acquiring unit 239 detects, with the operation device 183, which of selection buttons for selecting a settlement method displayed on the display device 182 of the self-service POS terminal 130 was pressed, thereby acquiring a settlement method instructed by the customer.

The settlement processing unit 240 performs settlement with the settlement method acquired by the settlement method acquiring unit 239. If cash settlement was selected, the settlement processing unit 240 receives cash with the change machine 188 included in the self-service POS terminal 130. If cashless settlement was selected, the settlement processing unit 240 reads, with the card reader 186 included in the self-service POS terminal 130, according to the settlement method, registration information of a credit card of the customer, a charge amount of an electronic money card of the customer, or the like and causes a not-illustrated external server, which performs settlement processing, to perform settlement.

The settlement completion information display unit 241 displays, on the display device 182 of the self-service POS terminal 130, information indicating that the settlement was completed and transaction content.

The receipt dispensing unit 242 dispenses, from the receipt printer 187 included in the self-service POS terminal 130, a receipt on which settlement content is printed.

### Flow of Processing Performed by the Self-Service POS Terminal

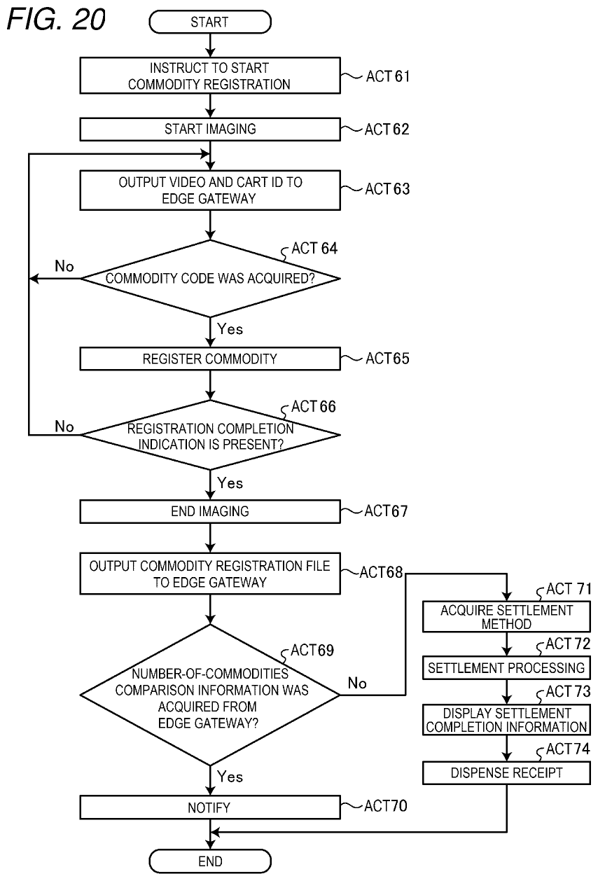

A flow of processing performed by the self-service POS terminal 130 is explained with reference to FIG. 20. FIG. 20 is a flowchart illustrating an example of the flow of the processing performed by the self-service POS terminal.

The commodity registering unit 232 detects, with the operation device 183, that a shopping start button displayed on the display device 182 was pressed, thereby acquiring an indication that commodity registration was started (Act 61).

The imaging control unit 233 causes the camera 189 to start capturing a video (Act 62).

The video output unit 234 outputs the video captured by the camera 189 and the identification number of the self-service POS terminal 130 to the edge gateway 20 in correlation with each other (Act 63).

The commodity code acquiring unit 231 determines whether a commodity code was acquired from a code symbol read by the scanner 184 or the hand scanner 185 (Act 64). If it is determined that a commodity code was acquired (Yes in Act 64), the processing proceeds to Act 65. On the other hand, if it is not determined that a commodity code was acquired (No in Act 64), the processing returns to Act 63.

If it is determined in Act 64 that a commodity code was acquired, the commodity registering unit 232 registers, in the commodity registration file 167, a commodity having the commodity code acquired by the commodity code acquiring unit 231 (Act 65).

The commodity registration completion indication acquiring unit 235 determines whether an indication that the commodity registration was completed is present (Act 66). If it is determined that an indication that the commodity registration was completed is present (Yes in Act 66), the processing proceeds to Act 67. On the other hand, if it is not determined that an indication that the commodity registration was completed is present (No in Act 66), the processing returns to Act 63. Note that the commodity registration completion indication acquiring unit 235 detects, with the operation device 183, that a checkout button displayed on the display device 182 was pressed, thereby determining that an indication that the commodity registration was completed is present.

If it is determined in Act 66 that an indication that the commodity registration was completed is present, the imaging control unit 233 instructs the camera 189 to end the imaging (Act 67). Note that, although not described in the flowchart of FIG. 20, at this time, the video output unit 234 ends the output of the video to the edge gateway 20.

The commodity registration information output unit 236 outputs the commodity registration file 167 to the edge gateway 20 (Act 68).

The number-of-commodities comparison information acquiring unit 237 determines whether number-of-commodities comparison information was acquired from the edge gateway 20 (Act 69). If it is determined that number-of-commodities comparison information was acquired (Yes in Act 69), the processing proceeds to Act 70. On the other hand, if it is not determined that number-of-commodities comparison information was acquired (No in Act 69), the processing proceeds to Act 71.

If it is determined in Act 69 that number-of-commodities comparison information was acquired, the alert control unit 238 causes the warning lamp 190 to light or flash, thereby alerting a store clerk (Act 70). Thereafter, the self-service POS terminal 130 ends the processing.

On the other hand, if it is not determined in Act 69 that number-of-commodities comparison information was acquired, the settlement method acquiring unit 239 detects, with the operation device 183, which of selection buttons for selecting a settlement method displayed on the display device 182 of the self-service POS terminal 130 was pressed, thereby acquiring a settlement method instructed by a customer (Act 71).

The settlement processing unit 240 performs settlement processing corresponding to the settlement method acquired in Act 71 (Act 72).

The settlement completion information display unit 241 displays, on the display device 182 of the self-service POS terminal 130, information indicating that the settlement was completed and transaction content (Act 73).

The receipt dispensing unit 242 dispenses, from the receipt printer 187 included in the self-service POS terminal 130, a receipt on which settlement content is printed (Act 74). Thereafter, the self-service POS terminal 130 ends the processing.

### Action Effects of the Embodiment

As explained above, in the commodity sales data processing system in the second embodiment, if a first number and a second number do not match, the first number and the second number are notified to the self-service POS terminal 130 (the terminal apparatus) that causes a customer to perform, by himself or herself, registration and settlement for a commodity to be purchased by the customer. Therefore, it is possible to, without substantially remodeling the self-service POS terminal of the related art, securely find a fraudulent act of the customer putting a commodity in a basket or a bag without reading a code symbol with the scanner 184 or the hand scanner 185 in the self-service POS terminal and alert a store clerk.

The embodiments are explained above. However, these embodiments are exemplifications and are not intended to limit the scope of the invention. These new embodiments can be implemented in other various forms. Various omissions, substitutions, and changes can be made without departing from the gist of the invention. The embodiments and modifications thereof are included in the scope and the gist of the invention and included in the scope of the inventions described in the claims and equivalents of the inventions.

What is claimed is:

1. A commodity registration support apparatus that reads information for uniquely specifying a commodity to be purchased, thereby supporting an operation of a commodity registration apparatus that registers the commodity, the commodity registration support apparatus comprising: a video acquiring component configured to acquire a video of the commodity, information of which is read, delivered into a storing compartment that stores the commodity, the video captured by an imaging apparatus that images the storing compartment, and an identification number for identifying the storing compartment;
a counting component configured to count, from the video acquired by the video acquiring component, a first number that is a number of commodities put in the storing compartment;
a number-of-commodities acquiring component configured to acquire a second number that is a number of commodities read by the commodity registration apparatus until registration completion; and
a number-of-commodities comparison information output component configured to output, on condition that the first number and the second number do not match, the identification number, the first number, and the second number in order to cause a terminal apparatus to alert a store clerk.

2. The commodity registration support apparatus according to claim 1, wherein the video acquiring component acquires a video captured by the imaging apparatus for a period from when a commodity registration start is instructed to the commodity registration apparatus until when commodity registration completion is indicated.

3. The commodity registration support apparatus according to claim 1, wherein the terminal apparatus is a portable apparatus carried by the store clerk of a store.

4. The commodity registration support apparatus according to claim 1, wherein the terminal apparatus is a self-service POS terminal that causes a customer to perform, by himself or herself, registration and settlement for a commodity to be purchased by the customer.

5. The commodity registration support apparatus according to claim 1, wherein the counting component uses skeleton estimation image processing to generate the first number.

6. The commodity registration support apparatus according to claim 1, wherein the first number and the second number are sent to and compared at an edge gateway via a plurality of wireless communication access points.

7. A commodity sales data processing system, comprising:
a scanner installed in a shopping cart and configured to read a code symbol attached to a commodity and including an identification number of the commodity;
an imaging apparatus installed in the shopping cart and configured to capture a video of the commodity, the code symbol of which is read, delivered into a storing compartment of the shopping cart;
a commodity registration support apparatus configured to acquire the video and an identification number of the shopping cart, count a first number that is a number of commodities put in the shopping cart, acquire a second number that is a number of commodities read by the scanner until registration completion, and output the identification number, the first number, and the second number on condition that the first number and the second number do not match;
a terminal apparatus carried by a store clerk and configured to alert the store clerk on condition that the identification number, the first number, and the second number output by the commodity registration support apparatus are acquired;
a commodity registration apparatus configured to register the commodity scanned by the scanner; and
a checkout apparatus configured to perform settlement processing relating to the commodity registered by the commodity registration apparatus.

8. The commodity sales data processing system according to claim 7, wherein the scanner comprises a barcode reader.

9. The commodity sales data processing system according to claim 7, wherein the commodity registration support apparatus acquires a video captured by the imaging apparatus for a period from when a commodity registration start is instructed to the commodity registration apparatus until when commodity registration completion is indicated.

10. The commodity sales data processing system according to claim 7, wherein the terminal apparatus is a portable apparatus carried by the store clerk of a store.

11. The commodity sales data processing system according to claim 7, wherein the terminal apparatus is a self-service POS terminal that causes a customer to perform, by himself or herself, registration and settlement for a commodity to be purchased by the customer.

12. The commodity sales data processing system according to claim 7, wherein the first number and the second number are sent to and compared at an edge gateway via a plurality of wireless communication access points.

13. The commodity sales data processing system according to claim 7, wherein the first number and the second number are sent to and compared at a store server via a plurality of wireless communication access points.

14. A method of reading information for uniquely specifying a commodity to be purchased, thereby supporting an operation of a commodity registration apparatus that registers the commodity, the method comprising:
acquiring a video of the commodity, the information of which is read, delivered into a storing compartment that stores the commodity, the video being captured by an imaging apparatus that images the storing compartment, and an identification number for identifying the storing compartment;
counting, from the acquired video, a first number that is a number of commodities put in the storing compartment;
acquiring a second number that is a number of commodities read until registration completion; and
outputting, on condition that the first number and the second number do not match, the identification number, the first number, and the second number in order to cause a terminal apparatus to alert a store clerk.

15. The method according to claim 14, further comprising:
scanning a barcode of the commodity.

16. The method according to claim 14, further comprising:
acquiring a video captured by the imaging apparatus for a period from when a commodity registration start is instructed to the commodity registration apparatus until when commodity registration completion is indicated.

17. The method according to claim 14, wherein the terminal apparatus is a portable apparatus carried by the store clerk of a store.

18. The method according to claim 14, further comprising:
causing a customer to perform, by himself or herself, registration and settlement for a commodity to be purchased by the customer.

19. The method according to claim 14, further comprising:
sending and comparing the first number and the second number at an edge gateway via a plurality of wireless communication access points.

20. The method according to claim 14, further comprising:
sending and comparing the first number and the second number at a store server via a plurality of wireless communication access points.
